(19) United States
(12) Patent Application Publication
(10) Pub. No.: US 2024/0217164 A1
(43) Pub. Date: Jul. 4, 2024

(54) SYSTEM AND METHOD FOR TREATING PLASTIC FILMS

(71) Applicant: SYNCRO S.R.L., Busto Arsizio (VA) (IT)

(72) Inventors: Gabriele CACCIA, Busto Arsizio (VA) (IT); Paolo RIZZOTTI, Novara (NO) (IT); Enrico NAPPA, Induno Olona (VA) (IT)

(73) Assignee: SYNCRO S.R.L., Busto Arsizio (VA) (IT)

(21) Appl. No.: 18/557,429

(22) PCT Filed: Apr. 21, 2022
(86) PCT No.: PCT/IB2022/053722

§ 371 Date: Oct. 26, 2023

(30) Foreign Application Priority Data
Apr. 30, 2021 (IT) 102021000010994

(51) Int. Cl. B29C 55/06; B29L 7/00

(52) U.S. Cl. CPC B29C 55/06; B29L 2007/002

(57) ABSTRACT

A system for the treatment of plastic films is described. The system includes a stretching station which stretches the film by subjecting it to permanent longitudinal expansion and a reinforcing station upstream of the stretching station. The reinforcing station reinforces edge areas on opposite sides of the film while the film is advanced along a feed direction, so as to increase the transversal tensile strength of the edge areas of the film. The reinforcing station also increases the thickness of the edge areas of the film and, for this purpose, includes a pair of applicator devices, each of which are associated with a film edge zone and are arranged to apply additional material on the edge areas.

### TECHNICAL FIELD OF THE INVENTION

The present invention relates to a system and method for treating plastic films, in particular for producing plastic films by blown film process or cast process.

More particularly, the present invention relates to a system and method in which a plastic film, for example a flattened tubular film produced by blown film process or a film produced by cast process, is subjected to a permanent longitudinal expansion of considerable magnitude, for example up to 300-600% of the initial length, by passing between a series of stretching rollers in a stretching station (commonly known by the acronym MDO, from “Machine Direction Orientation”) in order to reduce the final thickness of the film and reduce the residual elasticity of the film, so as to obtain physical properties and mechanical properties (such as resistance to breakage, resistance to tearing and resistance to laceration) otherwise difficult to obtain with the blown film or cast process alone.

### STATE OF THE ART

It is well known that the film stretching operation obtained by blown film or cast process, which operation in the case of a film obtained by blown film process is carried out on the film after this latter has been flattened, is accompanied by an inevitable transversal contraction of the film (the so-called “neck-in” phenomenon) that is all the greater the greater the longitudinal expansion and the greater the distance between the rollers that impose such expansion. After the roller stretching station, the film has then a large central area, comprised between the two lateral edges, characterized by a relatively uniform longitudinal expansion and consequent reduction in thickness, while close to the lateral edges of the film the reduction in thickness is less than in the central area and, moreover, is non-uniform and irregular for an extension in width that depends on the extent of the expansion and on the neck-in phenomenon. The lateral strips of the film thus obtained, which are thicker and more irregular than the central area, must therefore be cut and removed, while only the central area of the film is collected on the reel, with higher or lower waste percentage depending mainly on the extent of the neck-in phenomenon, as well as on the width of the film.

FIG. 1 of the attached drawings shows an example of a film thickness profile following the stretching operation in a roller stretching station. The lateral strips of the film (whose width is indicated with X), i.e. the areas close to the lateral edges of the film, show an evident increase in thickness compared to the central area of the film and must therefore be discarded (to be then recycled). The width X of the lateral strips of film to be discarded depends mainly on the entity of the imposed elongation and of the consequent neck-in phenomenon, while it does not significantly depend on the width of the film. In percentage terms, the quantity of film to be discarded is very large for relatively narrow film widths and decreases as the film width increases. At percentages of elongation in the order of 300-600%, the total width of film to be discarded can reach 250-350 mm.

The economic impact of such a high production resulting in waste to be recycled is evident.

In order to increase the transverse tensile strength of edge areas of the film, EP 1 095 759 proposes to fold these edge areas on themselves so as to increase their thickness.

### SUMMARY OF THE INVENTION

It is therefore an object of the present invention to enable better control of the thickness profile of a film subjected to a stretching operation, by compensating as much as possible for the effects of variation in film thickness occurring during the stretching operation, so as to bring the highest possible fraction of film width to a final thickness value within a range of thicknesses that is considered admissible and thus minimise the width of the lateral strips of film to be discarded.

This object is fully achieved by virtue of a system for treating plastic films as defined in the annexed independent claim 1, as well as by virtue of a method for treating plastic films as defined in the annexed independent claim 10.

Further advantageous aspects of the system for treating plastic films according to the invention are defined in the dependent claims, the subject-matter of which is intended to form an integral part of the present description.

The present invention also relates to a system for the production of plastic films comprising a treatment system of the type specified above.

In summary, the present invention is based on the idea of providing, upstream of the stretching station, a reinforcing station arranged to reinforce edge areas of the film on the two opposite sides of the film, increasing the thickness of said areas by applying additional material.

The additional material may be of the same type as that of the film, in which case it is convenient to use material coming from the recycling of the film waste. Alternatively, the additional material may be a different material from that of the film, in which case it is preferable to use as an additional material a material compatible with that of the film so as to allow the reuse of the film waste.

In any case, increasing the thickness of the film in the edge areas and/or applying in these areas a material having physical properties different from those of the film do not have an impact on the finished product, since the edge areas will be anyway discarded at the end of the treatment, i.e. once the film has been stretched.

For the purposes of the present invention, the expression “reinforcing edge areas of the film” means increasing the transverse tensile strength of such areas of the film.

Furthermore, the present invention is applicable to both a monolayer film obtained by cast process and a flattened tubular film obtained by blown film process. Therefore, even if only the term “film” will be referred to in the following description and claims, for the sake of simplicity, this term is to be understood as also referring to a flattened tubular film.

The action of reinforcing the edge areas of the film makes it possible to reduce the tendency of these areas to yield under the tension of the central part of the film, which undergoes a planar deformation during the stretching operation. According to the well-known Dobroth-Erwin model, in the case of a plastic film subjected to a longitudinal stretching action, the central strip of the film undergoes a planar deformation, while the lateral strips of the film undergo a uniaxial deformation only, which causes the thickness in the central strip to decrease during the stretching action more rapidly than in the lateral strips. During the stretching action, in fact, the width of the central strip of the film decreases and, given the continuity of the material, this decrease in width causes the central strip to apply onto the two lateral strips a traction towards the centre of the film. Since the outer edges of the film are free, the lateral strips do not undergo an increase in their width but are entirely displaced inwards. In order to balance the volume of the lateral strips, where the length has increased and the width decreased, an increase in thickness occurs in these strips. Since the material is continuous, in the real case the final thickness profile of the film is not divided into three discontinuous zones but is modulated as shown in FIG. 1, where it can be seen that the thickness of the film slowly decreases from the outside to the inside, thus giving rise to lateral strips to be discarded having a width X which is high compared to the total width of the film.

Thanks to the present invention, the increased transverse tensile strength of the edge areas of the film has the effect that a progressively decreasing trend of the film thickness from the outside to the inside is no longer produced, but a discontinuity between the edge areas and the central area is obtained, with a width of the central area (with a thickness within the desired thickness range) greater than that of the prior art, and therefore with lateral strips to be discarded with a width less than that of the prior art (as shown in the diagram of FIG. 2, where the width of the lateral strips to be discarded is indicated with X′).

It has been experimentally ascertained that the width reduction of the lateral strips of film to be discarded obtainable by reinforcing the edge areas of the film in the reinforcement station of the system according to the present invention can easily reach 50%, even up to 65-75%, which means making it possible to use a considerable amount of material that would otherwise be discarded to be subsequently recycled.

It is also possible to alter the physical-mechanical properties of the longitudinal strips close to the right and left edges of the film also by means of heat treatment, given the known influence of the temperature of the film on its elasto-plastic behaviour in the deformation phase. By cooling the lateral strips, for example by blowing temperature-controlled air directly on these areas, an increase in the resistance of these areas to deformation is obtained, since a higher force is required to achieve the same deformation. Alternatively, or in addition, to cooling the lateral strips, it is also possible to heat the central strip of the film, so as to reduce the transverse tensile forces that the central strip of the film applies to the lateral strips.

### BRIEF DESCRIPTION OF THE DRAWINGS

Further features and advantages of the present invention will become clearer from the following description, which is given purely by way of non-limiting example with reference to the appended drawings, where:

FIG. 1 shows an example of a thickness profile of a plastic film following the stretching operation in a plant for the production of plastic film according to the prior art;

FIG. 2 shows an example of a thickness profile of a plastic film following the stretching operation in a plant for the production of plastic film comprising a treatment system according to the present invention;

FIG. 3 is a perspective view of an embodiment of the reinforcement station of a system for the treatment of plastic films according to the present invention;

FIG. 4 is a front view of the reinforcing station of FIG. 3;

FIG. 5 is a side view of the reinforcing station of FIG. 3; and

FIG. 6 is a sectional view of the reinforcing station of FIG. 3 through section line VI-VI of FIG. 4.

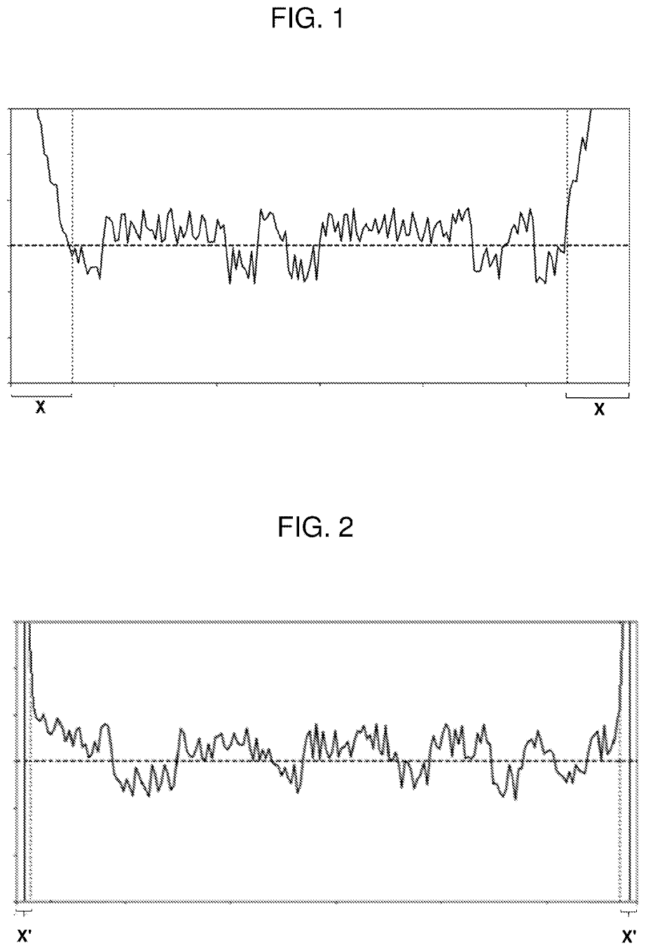

### DETAILED DESCRIPTION

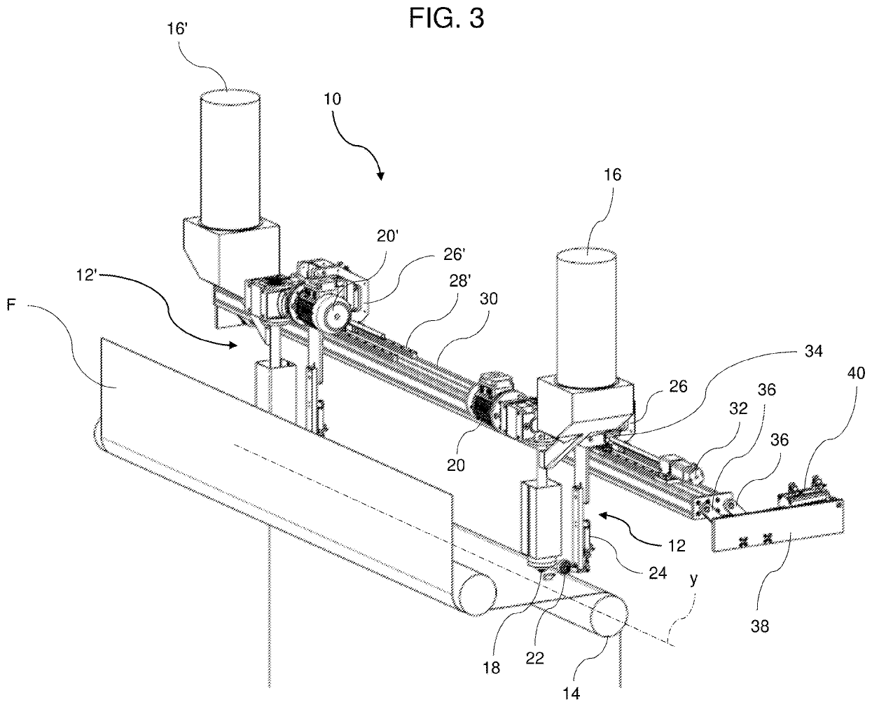

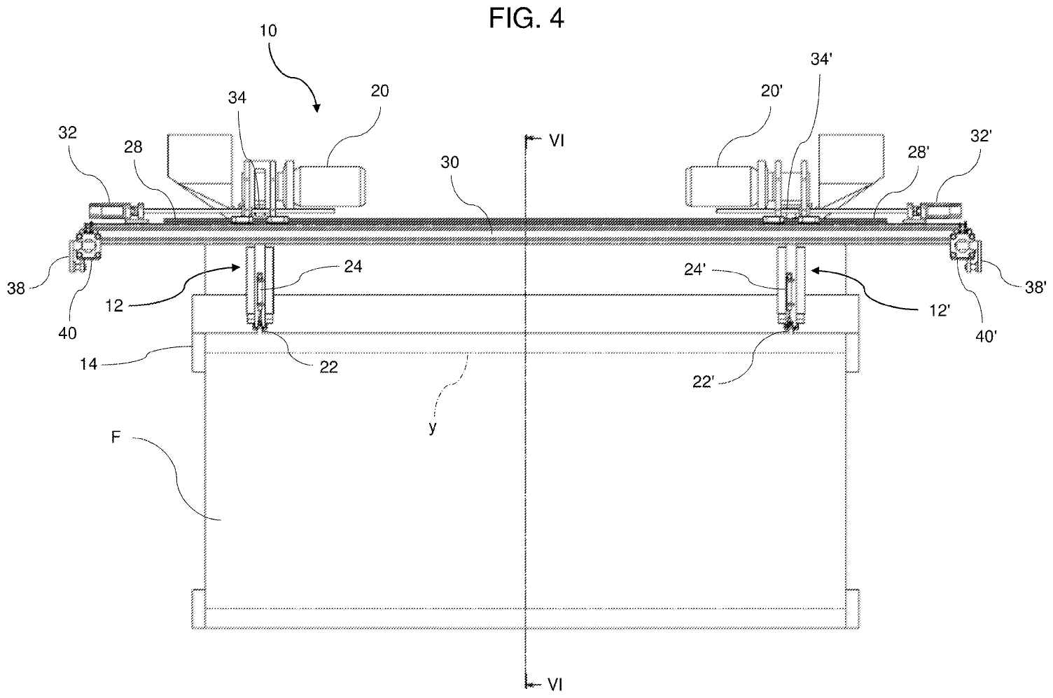

Referring first to FIGS. 3 and 4, a reinforcing station for a system for the treatment of plastic films, in particular blown films or cast films, is generally indicated with 10.

The reinforcing station 10 is intended to be installed upstream of a stretching station (not shown, but in any case of a type known per se) of the system, preferably close thereto, so as to reinforce the film (indicated with F) before it is subjected to stretching in the stretching station.

More specifically, the reinforcing station 10 is arranged to reinforce edge areas on the two opposite sides of the film F, said edge areas being close to the two left and right edges of the film or comprising these edges. The reinforcement of the edge areas of the film F is obtained by increasing the thickness of these areas with respect to the remaining central area of the film F. More specifically, the increase in thickness of the film F in the edge areas is obtained by applying and welding additional material to said areas. This additional material may be of the same type as the material of the film F, in particular material coming from the recycling of the waste of the same film, or alternatively be material different from that of the film F, in which case it is preferable that said different material is in any case compatible with that of the film so that it can be recycled together with the material of the film.

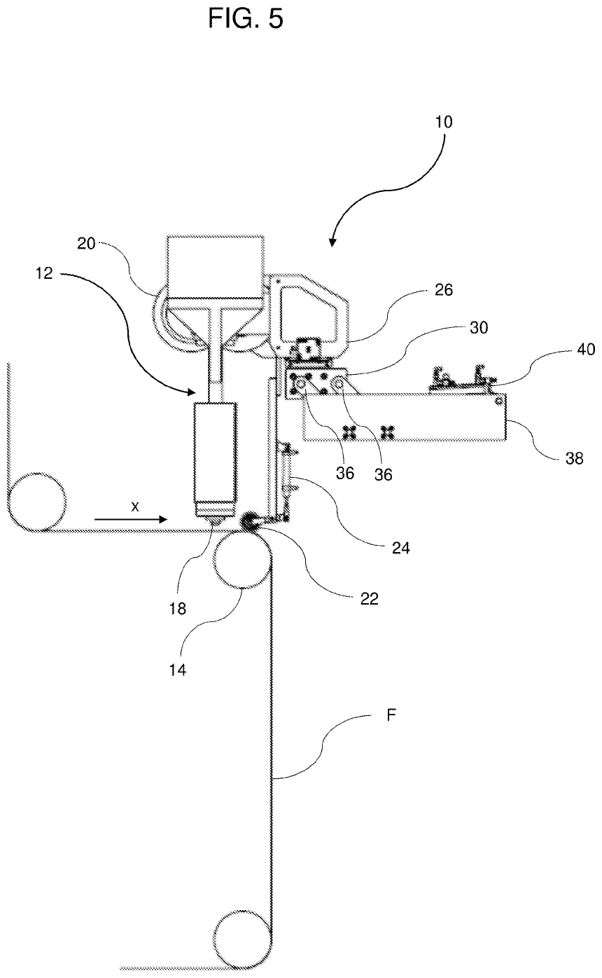

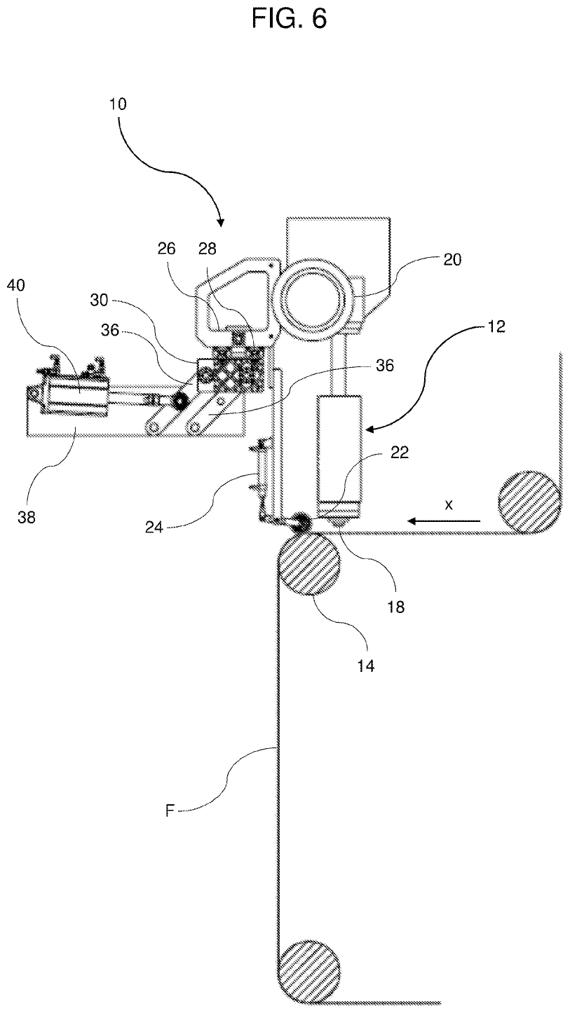

The reinforcing station 10 basically comprises a pair of applicator devices 12, 12′ which are arranged on opposite sides with respect to the centreline of the film F and are each arranged to apply the additional material on a respective edge area of the film F while the film F is advanced along a feed direction (indicated with x in FIGS. 5 and 6). In the present case, the feed direction x is horizontal, but the present invention is likewise applicable to the case where the section of film F on which the additional material is applied or, more generally, on which the reinforcement operation is carried out on the edge areas advances along a non-horizontal direction, for example in a vertical direction.

The applicator devices 12, 12′ are positioned close to a deflection cylinder 14 around which the film F is passed, in particular above said deflection cylinder. The deflection cylinder 14 may be a cylinder already normally present in the system, upstream of the stretching station, or be a cylinder specifically provided for the reinforcing station 10. The axis of rotation of the deflection cylinder 14 is indicated with y in FIGS. 3 and 4.

Each applicator device 12, 12′ basically comprises a respective reservoir 16, 16′ containing the additional material to be applied on the film F and a respective nozzle 18, 18′ facing downwards to dispense on the underlying film F the additional material from the respective reservoir 16, 16′. Instead of a single nozzle, each applicator device may have several nozzles arranged side by side, for example two nozzles.

Each applicator device 12, 12′ further comprises a respective motor 20, 20′ arranged to control respective dispensing means (not shown) for discharging through the respective nozzle 18, 18′ the additional material coming from the respective reservoir 16, 16′. The motors 20, 20′ are preferably arranged inwardly, i.e. towards the centre of the film F, so as to limit the external footprint of the reinforcement station 10.

Each applicator device 12, 12′ further comprises heating means (not shown) for heating the additional material exiting the respective nozzle 18, 18′, so that due to its higher temperature the additional material applied to the respective edge area of the film F melts said area of the film, thus ensuring welding of said area with the additional material. In the case, for example, where the film to be treated is a flattened tubular film coming from a blown film extrusion plant, the additional material dispensed by each applicator device must be able not only to melt the film layer on which it is laid, but also to bring the underlying film layer to a high temperature, or in any case to a temperature sufficient to ensure the welding of both film layers with the additional material.

Preferably, each applicator device 12, 12′ further comprises a respective pressure roller 22, 22′ positioned downstream of the respective nozzle 18, 18′, with respect to the feed direction x, and arranged to press on the respective edge area of the film to promote adhesion of the film with the additional layer of material dispensed onto the film by the respective nozzle 18, 18′. Each pressure roller 22, 22′ is advantageously associated with a respective spring 24, 24′, for example a gas spring, or a pneumatic cylinder, to exert on the respective pressure roller 22, 22′ a force tending to push the respective pressure roller 22, 22′ against the film F as the latter advances between the respective pressure roller 22, 22′ and the deflection cylinder 14.

The applicator devices 12, 12′ are movable along the transverse direction of the film F, i.e. in a direction perpendicular to the feed direction x, and therefore parallel to the axis of rotation y of the deflection roller 14, so as to be positionable at the edge areas of the film F to be reinforced, adapting to films of different widths. For this purpose, each applicator device 12, 12′ is carried by a respective carriage 26, 26′ slidably mounted along respective linear guides 28, 28′ extending parallel to the axis of rotation y of the deflection cylinder 14. The linear guides 28, 28′ are in turn mounted on a profile 30.

The carriages 26, 26′ are preferably movable along the respective linear guides 28, 28′ independently of each other by means of respective linear driving devices, each of which comprises for example a respective motor 32, 32′, in particular an electric motor, and a respective motion conversion mechanism 34, 34′, which in the embodiment proposed herein is a screw and nut mechanism.

In order to adjust the position of the applicator devices 12, 12′ with respect to the film F in the plane perpendicular to the axis of rotation y of the deflection cylinder 14, according to an embodiment of the invention the profile 30 is movable with respect to the deflection cylinder 14 by means of a driving system comprising, in the embodiment proposed herein, a pair of lever mechanisms each associated with a respective end of the profile 30 and each comprising a pair of parallel levers 36, 36′ hinged at their opposite ends on one side to the profile 30 and on the other side to respective support plates 38, 38′ which are in turn suitably mounted (in a manner not illustrated herein) on the system. With each lever mechanism there is associated a respective actuator 40, 40′, in particular a linear actuator, for example a pneumatic cylinder, interposed between the respective support plate 38, 38′ and one of the levers 36, 36′ of the respective lever mechanism. Thanks to such a driving system, it is possible to vary the position of the applicator devices 12, 12′ with respect to the film F, both in vertical and longitudinal directions.

Alternatively, in order to adjust the position of the applicator devices 12, 12′ with respect to the film F in the plane perpendicular to the axis of rotation y of the deflection cylinder 14, a driving system similar to the one described above might be provided, but interposed between the carriages 26, 26′ and the applicator devices 12, 12′. In this case, therefore, the profile 30 with the linear guides 28, 28′ would remain fixed with respect to the plant and the applicator devices 12, 12′ would be movable with respect to the profile 30 also in the plane perpendicular to the axis of rotation y, as well as parallel to the axis of rotation y.

In operation, therefore, once the position of the applicator devices 12, 12′ with respect to the film F has been adjusted, both in the transverse direction by means of the aforementioned linear driving devices and in the plane perpendicular to the transverse direction by means of the aforementioned driving system, the applicator devices 12, 12′ are suitably controlled by a control unit (not shown) which manages the operation of the apparatus to dispense a given amount of additional material, each on the respective edge area of the film F, at a given temperature. The layer of additional material applied on the film F adheres to the material of the film, both as a result of the melting of the film and as a result of the subsequent pressing action exerted by the pressure roller 22, 22′ downstream of the nozzle 18, 18′. In this way, the thickness of the edge areas of the film F, and therefore their transversal tensile strength, is increased, with the result that in the subsequent film stretching phase the width of the two lateral strips of the film to be discarded, as they have a thickness outside the acceptable thickness range, is reduced.

As an alternative to the foregoing, the applicator devices might be configured to apply additional material in the form of pre-cut strips or substrates, such pre-cut strips or substrates being secured to the film for example—although not necessarily—by gluing.

In addition, cooling devices may be provided to cool the edge areas of the film, for example by blowing temperature-controlled air directly onto said areas, in order to produce an increase in the resistance of said areas to deformation. As an alternative or in addition to such cooling devices, one or more heating devices may be provided for heating the central strip of the film, so as to reduce the transverse tensile forces that the central strip of the film applies to the lateral strips.

The present invention has been described so far with reference to some preferred embodiments thereof. It is to be understood that other embodiments may be envisaged, which share to the same inventive core and thus fall within the scope of protection of the claims set forth below.

For example, the reinforcing station and the stretching station which are part of the system for treating plastic films according to the invention and which perform, respectively, the operation of reinforcing the edge areas of the film and the operation of stretching the film in the method according to the invention do not necessarily have to be arranged along the same working line, but may also be arranged on different lines.

What is relevant for the purposes of the present invention is that prior to the film stretching operation in the stretching station the edge areas of the film are reinforced, i.e. their transverse tensile strength is increased.

In the case of a plant for the production of blown plastic films, i.e. films obtained by blown film process, the film reinforcement operation may also be performed upstream of the pulling operation by suitably adjusting the thickness profile of the tubular film so as to have edge areas of the tubular film which are thicker, and therefore more resistant to transverse traction, than the central area of the tubular film.

Furthermore, although the system and the method according to the invention have been described herein with particular reference to their use in the production of plastic films, they are likewise usable in other fields, for example in the field of plastic film printing.

1. A system for treating a plastic films, comprising a stretching station arranged to stretch the film by subjecting the same to permanent longitudinal expansion, and, upstream of the stretching station, a reinforcing station arranged to reinforce edge areas on opposite sides of the film, while the film is advanced along a feed direction, so as to increase the transversal tensile strength of said edge areas of the film, wherein the reinforcing station is configured to increase a thickness of said edge areas of the film, and wherein the reinforcing station comprises a pair of applicator devices, which are associated each with a respective edge area of the film and are arranged to apply additional material on said edge areas of the film.

2. The system of claim 1, wherein each applicator device comprises at least one nozzle for dispensing the additional material on the respective edge area of the film and heating means for heating the additional material dispensed through the respective nozzle or nozzles.

3. The system of claim 2, wherein the reinforcing station further comprises a deflection cylinder around which the film is caused, in use, to move in its advancing movement, and wherein each applicator device further comprises a pressure roller which is placed downstream of the respective nozzle and is configured to cooperate with the deflection cylinder to press on the layer of additional material applied on the respective edge area of the film.

4. The system of claim 3, wherein each applicator device further comprises spring means or actuator means acting on the respective pressure roller to push it towards the film.

5. The system of claim 1, wherein each applicator device is configured to apply additional material in the form of pre-cut strips or substrates.

6. The system of claim 1, wherein the reinforcing station further comprises first driving means arranged to move the applicator devices in a transverse direction, i.e. perpendicular to said feed direction, so as to position each applicator device at the respective edge area of the film.

7. The system according of claim 6, wherein said first driving means comprise linear guides directed along said transverse direction, a pair of carriages slidably mounted along the linear guides and each carrying a respective applicator device, and first motor means arranged to control the sliding movement of the carriages along the linear guides independently of each other.

8. The system of claim 7, wherein the reinforcing station further comprises second driving means arranged to move the applicator devices in a plane perpendicular to said transverse direction.

9. A plant for producing plastic films (F) by blown film processor cast process, comprising a system according to claim 1.

10. A method for treating a plastic film (F), comprising the operation of stretching the film by subjecting it to permanent longitudinal expansion and, prior to said stretching operation, the operation of reinforcing edge areas on opposite sides of the film by increasing the thickness of said edge areas of the film, while the film is advanced along a feed direction, so as to increase the transversal tensile strength of said edge areas of the film, wherein said operation of reinforcing the edge areas of the film is performed by applying additional material on said edge areas.

11. The system of claim 5, wherein each applicator device is configured to bond said pre-cut strips or substrates to said edge areas of the film.
